(19) United States
(12) Patent Application Publication
(10) Pub. No.: US 2024/0324673 A1
(43) Pub. Date: Oct. 3, 2024

(54) An Aerosol Generating Article and an Aerosol Generating System

(71) Applicant: JT International SA, Geneva (CH)

(72) Inventor: Alec Wright, Guildford (GB)

(73) Assignee: JT International SA, Geneva (CH)

(21) Appl. No.: 18/580,468

(22) PCT Filed: Jul. 18, 2022
(86) PCT No.: PCT/EP2022/070025

§ 371 Date: Jan. 18, 2024

(30) Foreign Application Priority Data
Jul. 23, 2021 (EP) 21187325.2

(51) Int. Cl. A24F 40/42; A24F 40/10; A24F 40/46; A24F 40/465; H05B 3/22; H05B 6/10

(52) U.S. Cl. CPC A24F 40/42; A24F 40/10; A24F 40/46; A24F 40/465; H05B 3/22; H05B 6/108

(57) ABSTRACT

An aerosol generating article, for use with an aerosol generating device having a heating chamber, consists of a porous liquid storage material for storing an aerosol generating liquid and which is configured for insertion into the heating chamber. The porous liquid storage material includes an opening for receiving an elongate heating element of an aerosol generating device.

### TECHNICAL FIELD

The present disclosure relates generally to aerosol generating articles, and more particularly to an aerosol generating article for use with an aerosol generating device for heating the aerosol generating article to generate an aerosol for inhalation by a user. Embodiments of the present disclosure also relate to an aerosol generating system comprising an aerosol generating device and an aerosol generating article configured for use with the aerosol generating device. The present disclosure is particularly applicable to an aerosol generating article for use with a portable (hand-held) aerosol generating device.

### TECHNICAL BACKGROUND

The popularity and use of reduced-risk or modified-risk devices (also known as aerosol generating devices or vapour generating devices or personal vaporizers) has grown rapidly in recent years as an alternative to the use of traditional tobacco products. These devices heat, rather than burn, an aerosol generating substrate to generate an inhalable aerosol and can use one of a number of different approaches to provide heat to the aerosol generating substrate

One approach is to provide an aerosol generating device which employs a resistive heating system. In such a device, a resistive heating element is provided to heat the aerosol generating substrate.

Another approach is to provide an aerosol generating device which employs an induction heating arrangement comprising an induction coil and a susceptor. An alternating electrical current is supplied to the induction coil when a user activates the device which in turn generates an alternating electromagnetic field that couples with, and inductively heats, the susceptor. Heat from the susceptor is transferred to the aerosol generating substrate.

In some conventional aerosol generating devices, the aerosol generating substrate is an aerosol generating liquid (or so called “e-liquid”), for example containing one or more of nicotine, propylene glycol, glycerine and flavourings. The aerosol generating liquid is typically stored in a liquid store of the aerosol generating device. The aerosol generating liquid is transferred from the liquid store by a liquid transfer element, such as a wick, and is heated and vaporized by heat transferred from the resistive heating element or the susceptor, resulting in the generation of a vapour which cools and condenses to form an inhalable aerosol. The aerosol generating liquid, liquid transfer element and resistive heating element or susceptor can be provided together in a replaceable cartridge (cartomizer) that is configured for use with the vapour generating device.

Cartomizers used with conventional aerosol generating devices comprise several component parts and have a complex construction. The present disclosure seeks to address at least these drawbacks.

### SUMMARY OF THE DISCLOSURE

According to a first aspect of the present disclosure, there is provided an aerosol generating article for use with an aerosol generating device having a heating chamber, the aerosol generating article comprising:
a porous liquid storage material for storing an aerosol generating liquid and configured for insertion into the heating chamber, the porous liquid storage material including an opening for receiving an elongate heating element of an aerosol generating device.

According to a second aspect of the present disclosure, there is provided an aerosol generating system comprising:
an aerosol generating device comprising a heating chamber and an elongate heating element which projects into the heating chamber; and
an aerosol generating article positioned in the heating chamber, the aerosol generating article comprising:
   a porous liquid storage material storing an aerosol generating liquid; and
   an opening in which the elongate heating element is positioned for heating and vaporising the stored aerosol generating liquid.

The aerosol generating article is configured for use with an aerosol generating device for heating the aerosol generating liquid stored in the porous liquid storage material, without burning the aerosol generating liquid, to volatise at least one component of the aerosol generating liquid and thereby generate a heated vapour which may cool and condense to form an aerosol for inhalation by a user of the aerosol generating device. The aerosol generating device is a hand-held, portable, device.

In general terms, a vapour is a substance in the gas phase at a temperature lower than its critical temperature, which means that the vapour can be condensed to a liquid by increasing its pressure without reducing the temperature, whereas an aerosol is a suspension of fine solid particles or liquid droplets, in air or another gas. It should, however, be noted that the terms ‘aerosol’ and ‘vapour’ may be used interchangeably in this specification, particularly with regard to the form of the inhalable medium that is generated for inhalation by a user.

The aerosol generating article conveniently comprises a capsule or cartridge for insertion into the heating chamber of the aerosol generating device. The aerosol generating article is a consumable article that can be easily removed from the heating chamber when the aerosol generating liquid in the porous liquid storage material has been depleted, allowing a replacement aerosol generating article to be inserted into the heating chamber. By providing an opening in the porous liquid storage material for receiving the elongate heating element of an aerosol generating device, efficient and rapid heating and vaporization of the aerosol generating liquid is achieved, thereby improving both the aerosol generation capabilities and the energy efficiency of the aerosol generating device. The aerosol generating article also has a simple construction that uses a small number of component parts and materials, thereby facilitating its manufacture and minimising its environmental impact. Advantageously, the aerosol generating article consists of the porous liquid storage material. Thus, the aerosol generating article does not include any components other than the porous liquid storage material. By eliminating other components, the aerosol generating article has a compact size and is more easily disposable and recyclable. Advantageously, the porous liquid storage material is not refillable by a user. Thus, the amount of aerosol generating liquid stored in the porous liquid storage material at the time of manufacture of the aerosol generating article determines the amount of vapour or aerosol that can be generated during use of the aerosol generating article in an aerosol generating device.

The porous liquid storage material may comprise a self-supporting material. The aerosol generating article can be easily stored and handled by a user.

The porous liquid storage material may comprise a high retention material. A “high retention material” is a material that is capable of absorbing and/or storing aerosol generating liquid and that has a high retention capacity for the aerosol generating liquid. In this sense, the aerosol generating liquid is safely held or retained in the high retention material. The high retention material may be capable of storing a sufficient quantity of aerosol generating liquid for a desired period of use (e.g., a predetermined number of puffs). The high retention material may have a fibrous or spongy structure. The high retention material may include sponge-like or foam-like material. The high retention material may include any suitable material or combination of materials. Examples of suitable high retention materials are ceramic- or graphite-based materials in the form of fibres or sintered powders. In an exemplary embodiment, the high retention material may be a porous ceramic material.

The porous liquid storage material typically comprises a non-inductively heatable material, for example an electrically non-conductive and paramagnetic or diamagnetic material. Thus, the porous liquid storage material is not inductively heated in the presence of an alternating electromagnetic field.

The opening may be positioned substantially centrally within the cross-section of the porous liquid storage material. Thus, the porous liquid storage material may have a substantially annular shape which may define a centrally positioned opening. The provision of a centrally positioned opening ensures that there is a uniform transfer of heat from the elongate heating element to the liquid stored in the porous liquid storage material and, thus, facilitates vapour generation. The centrally positioned opening may also help to facilitate the correct positioning of the aerosol generating article in the heating chamber. The annular porous liquid storage material may have a circular, square, hexagonal or tetrahedral cross-sectional shape.

The elongate heating element may be in thermal contact with an inner surface of the porous liquid storage material defined by the opening. This further ensures that an efficient and uniform transfer of heat, e.g., by conduction, is achieved from the elongate heating element to the porous liquid storage material.

The elongate heating element may comprise a pin heater or a blade heater. This shape of heating element is particularly suitable for insertion into the opening of the porous liquid storage material and may provide a good thermal contact with an inner surface of the porous liquid storage material defined by the opening.

The aerosol generating device may comprise a further heating element which may surround the porous liquid storage material. This may further enhance the heating of the porous liquid storage material, because the porous liquid storage material is heated both internally by the elongate heating element and externally by the further heating element, and may thus enhance the vapour or aerosol generation capabilities of the aerosol generating device.

The further heating element may be mounted on a side wall of the heating chamber or may be defined by a side wall of the heating chamber. The further heating element may be in thermal contact with an outer surface of the porous liquid storage material. This ensures that an efficient and uniform transfer of heat, e.g., by conduction, is achieved from the further heating element to the porous liquid storage material.

The heating element (i.e., the elongate heating element and/or the further heating element) may comprise a resistance heating element. The aerosol generating device may, thus, have a simple and compact design.

The heating element (i.e., the elongate heating element and/or the further heating element) may comprise an inductively heatable susceptor. The aerosol generating device may further comprise an induction heating arrangement for generating an alternating electromagnetic field for penetrating the inductively heatable susceptor to thereby inductively heat the inductively heatable susceptor. By using an inductively heatable susceptor as the heating element in combination with an induction heating arrangement, efficient and rapid heating of the porous liquid storage material is achieved, thereby improving both the aerosol generation capabilities and the energy efficiency of the aerosol generating device.

The inductively heatable susceptor may comprise an electrically conductive material and may comprise a metal. The metal is typically selected from the group consisting of stainless steel and carbon steel. The inductively heatable susceptor could, however, comprise any suitable material including one or more, but not limited, of aluminium, iron, nickel, stainless steel, carbon steel, and alloys thereof, e.g. Nickel Chromium or Nickel Copper. With the application of an electromagnetic field in its vicinity during use of the aerosol generating article in an aerosol generating device, the inductively heatable susceptor may generate heat due to eddy currents and/or magnetic hysteresis losses resulting in a conversion of energy from electromagnetic to heat.

The induction heating arrangement may comprise an induction coil which may extend around the heating chamber. The induction coil may, for example, extend around an outer wall of the heating chamber. The induction coil may have a shape which substantially corresponds to the shape of the heating chamber. For example, the induction coil may be a helical coil.

The induction coil may comprise a Litz wire or a Litz cable. It will, however, be understood that other materials could be used.

The induction coil may be arranged to operate in use with a fluctuating electromagnetic field having a magnetic flux density of between approximately 20 mT and approximately 2.0T at the point of highest concentration.

The aerosol generating device may include a power source and may include a controller with may include circuitry. The power source and circuitry may be configured to operate at a high frequency. The power source and circuitry may be configured to operate at a frequency of between approximately 80 kHz and 500 kHz, possibly between approximately 150 kHz and 250 kHz, and possibly at approximately 200 kHz. The power source and circuitry could be configured to operate at a higher frequency, for example in the MHz range, depending on the type of inductively heatable susceptor that is used.

The aerosol generating liquid may comprise polyhydric alcohols and mixtures thereof such as glycerine or propylene glycol. The aerosol generating liquid may contain nicotine. The aerosol generating liquid may contain other additives and ingredients, such as flavourants. The term “aerosol generating liquid” used herein includes any non-solid material, e.g., a semi-liquid material such as a gel or a wax, capable of generating a vapour or aerosol when heated.

### BRIEF DESCRIPTION OF THE DRAWINGS

FIG. 1 is a diagrammatic perspective view of a first example of an aerosol generating article;

FIG. 2 is a diagrammatic cross-sectional view of a first example of an aerosol generating system comprising an aerosol generating device and the first example of the aerosol generating article of FIG. 1, showing the aerosol generating article prior to being positioned in a heating chamber of the aerosol generating device:

FIG. 3 is a diagrammatic cross-sectional view of the first example of the aerosol generating system of FIG. 2, showing the first example of the aerosol generating article positioned in the heating chamber of the aerosol generating device;

FIG. 4 is a diagrammatic cross-sectional view of a second example of an aerosol generating system comprising an aerosol generating device and the first example of the aerosol generating article of FIG. 1, showing the aerosol generating article prior to being positioned in a heating chamber of the aerosol generating device; and

FIG. 5 is a diagrammatic cross-sectional view of the second example of the aerosol generating system of FIG. 4, showing the first example of the aerosol generating article positioned in the heating chamber of the aerosol generating device.

### DETAILED DESCRIPTION OF EMBODIMENTS

Embodiments of the present disclosure will now be described by way of example only and with reference to the accompanying drawings.

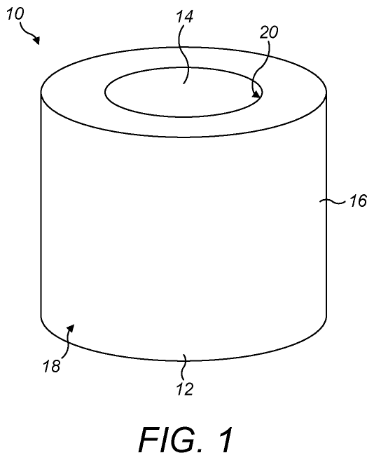

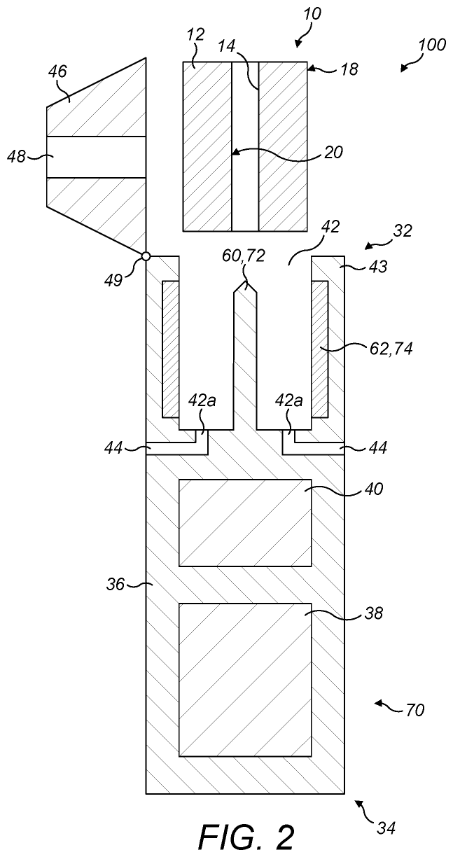

Referring initially to FIG. 1, there is shown a first example of an aerosol generating article 10 for use with an aerosol generating device 30, 70, examples of which will be described below with reference to FIGS. 2 to 5. The aerosol generating article 10 is a consumable article, is substantially cylindrical and may be regarded as a capsule or cartridge for use with the aerosol generating device 30, 70. The circular cross-section facilitates handling of the aerosol generating article 10 by a user and insertion of the aerosol generating article 10 into a heating chamber 42 of an aerosol generating device 30, 70. It should, however, be noted that a circular cross-section is not essential and that other cross-sectional shapes, such as square, hexagonal or tetrahedral, are within the scope of the present disclosure.

The aerosol generating article 10 comprises a porous liquid storage material 12 that stores or holds an aerosol generating liquid. The aerosol generating liquid may comprise an aerosol-forming substance such as propylene glycol and/or glycerol and may contain other substances such as nicotine and acids. The aerosol generating liquid may also comprise flavourings such as, e.g., tobacco, menthol or fruit flavour. The porous liquid storage material 12 typically comprises a high retention material, for example a porous ceramic, which enables the aerosol generating liquid to be readily absorbed and retained by the porous liquid storage material 12 without any leakage. The porous liquid storage material 12 is a non-inductively heatable material, meaning that it is not inductively heated in the presence of an electromagnetic field.

The porous liquid storage material 12 has a substantially annular shape and defines a centrally positioned opening 14. The centrally positioned opening 14 is configured to receive an elongate heating element 60 of an aerosol generating device 30, 70 as will be explained in further detail below. The centrally positioned opening 14 may also facilitate the positioning of the aerosol generating article 10 in a heating chamber 42 of an aerosol generating device 30, 70, and may also act as a vaporization chamber and/or vapour outlet channel.

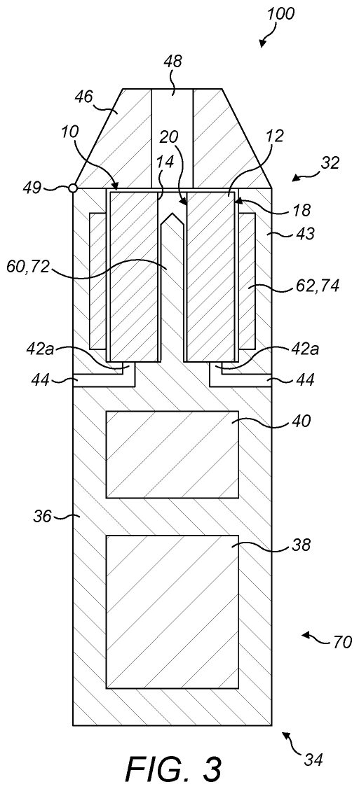

Referring now to FIGS. 2 and 3, there is shown a first example of an aerosol generating system 100. The aerosol generating system 100 comprises an electrically-operated aerosol generating device 70 and the first example of the aerosol generating article 10 described above. The aerosol generating device 70 has a proximal end 32 and a distal end 34 and comprises a device body 36 which includes a power source 38 and a controller 40. The power source 38 typically comprises one or more batteries which could, for example, be inductively rechargeable.

The aerosol generating device 70 comprises a substantially cylindrical heating chamber 42 having one or more air inlets 42a. The heating chamber 42 is positioned at the proximal end 32 of the aerosol generating device 70 and is arranged to receive the aerosol generating article 10. The aerosol generating device 70 includes a plurality of air inlets 44 formed in the device body 36 which deliver air to the heating chamber 42 via the air inlets 42a.

The aerosol generating device 70 includes a mouthpiece portion 46 including an outlet 48. In the illustrated example, the mouthpiece portion 70 is connected to the device body 36 by a hinged connection 49, but any kind of connection may be used, such as a snap-fit connection, a bayonet connection, or a screw fitting.

The aerosol generating device 70 comprises an elongate heating element 60 that projects into the heating chamber 42 from a distal end towards a proximal end. The elongate heating element 60 is a resistance heating element 72 and extends into the centrally positioned opening 14 in the porous liquid storage material 12 as shown in FIG. 3 where it thermally contacts the inner surface 20 of the porous liquid storage material 12. The aerosol generating device 70 also comprises an optional further heating element 62 which surrounds the porous liquid storage material 12. The optional further heating element 62 is mounted on, or defined by, a side wall 43 of the heating chamber 42 and thermally contacts the outer surface 18 of the porous liquid storage material 12. The further heating element 62 is also a resistance heating element 74. The resistance heating elements 72, 74 are both operatively connected to the power source 38 and controller 40. As will be understood by one of ordinary skill in the art, when an electric current is passed through the resistance heating elements 72, 74, heat is generated by virtue of Joule heating.

When the aerosol generating article 10 is positioned in the heating chamber 42 as shown in FIG. 3 and the resistance heating elements 72, 74 are activated during use of the aerosol generating system 100 by passing an electric current through the resistance heating elements 72, 74, the heat from the resistance heating elements 72, 74 is transferred to the porous liquid storage material 12, primarily by conduction but possibly also by radiation and/or convection. The aerosol generating liquid stored in the porous liquid storage material 12 is thereby heated to a temperature at which one or more volatile components are released, causing the aerosol generating liquid to be vaporised and a vapour to be generated.

The vaporisation of the aerosol generating liquid stored in the porous liquid storage material 12 is facilitated by the addition of air from the surrounding environment through the air inlets 44, 42a. The vapour generated by heating the aerosol generating liquid is released from the porous liquid storage material 12 thanks to its porosity and may cool and condense to form an aerosol. At least some of the vapour may be released into the centrally positioned opening 14 and, indeed, some vaporization of the stored aerosol generating liquid may take place in the centrally positioned opening 14. The vapour or aerosol passes through the outlet 48 in the mouthpiece portion 46 and is inhaled by a user. It will be understood that the flow of air through the aerosol generating device 30, i.e., from the air inlets 44, 42a, through the porous liquid storage material 12, and through the outlet 48 of the mouthpiece portion 46, is aided by negative pressure created by a user drawing air from the outlet side of the aerosol generating device 30 through the mouthpiece portion 46.

Prior to using the aerosol generating system 100, a user must first pivot the mouthpiece portion 46 to the open position shown in FIG. 2 and insert an aerosol generating article 10 into the heating chamber 42. The user can then pivot the mouthpiece portion 46 to the closed position as shown in FIG. 3 so that the aerosol generating system 100 is ready for use. The aerosol generating device 70 can then be activated (e.g., by a button press) to supply an electric current to the resistance heating element 72 and to the optional resistance heating element 74 in the manner described above to generate an inhalable aerosol. When the aerosol generating article 10 becomes depleted and no longer releases sufficient volatile components to generate an aerosol with acceptable qualities, the aerosol generating article 10 can be removed from the heating chamber 42 after pivoting the mouthpiece portion 46 to the open position, and a replacement aerosol generating article 10 can be inserted into the heating chamber 42 in its place.

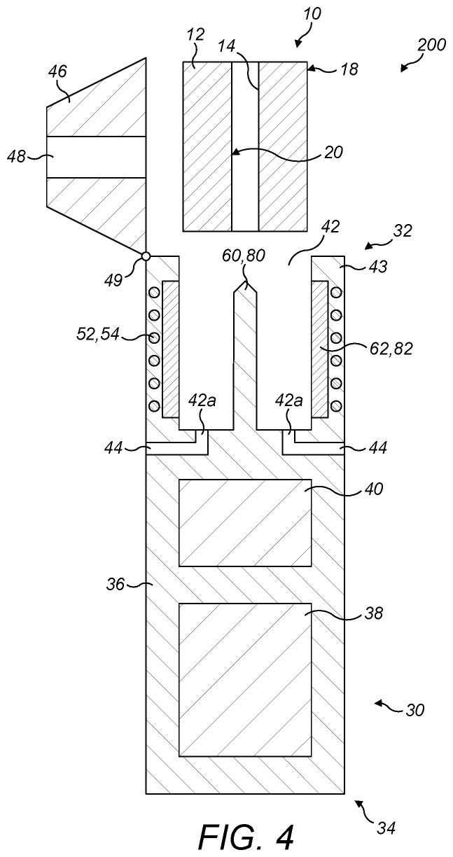

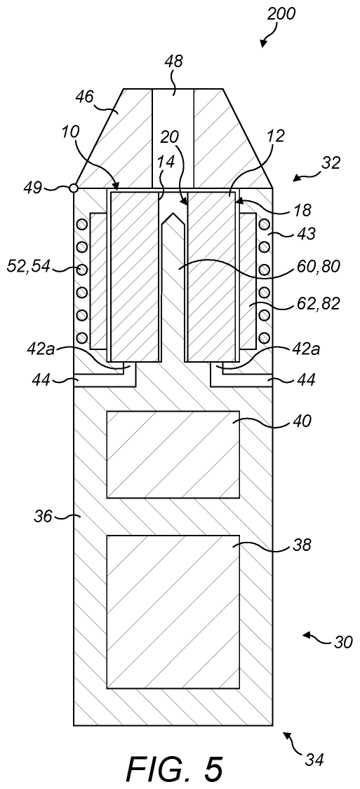

Referring now to FIGS. 4 and 5, there is shown a second example of an aerosol generating system 200. The aerosol generating system 200 is similar to the aerosol generating system 100 described above with reference to FIGS. 2 and 3 and corresponding components are identified using the same reference numerals. The aerosol generating system 200 comprises an electrically-operated aerosol generating device 30 and the first example of the aerosol generating article 10 described above.

The aerosol generating device 30 comprises an elongate heating element 60. The elongate heating element 60 comprises an elongate inductively heatable susceptor 80 which typically comprises a metal and is inductively heatable in the presence of a time varying (alternating) electromagnetic field. The aerosol generating device 30 also comprises an optional further heating element 62 that is mounted on, or defined by, a side wall 43 of the heating chamber 42. The further heating element 62 also comprises an inductively heatable susceptor 82 that is inductively heatable in the presence of a time varying (alternating) electromagnetic field, and may comprise the same material (e.g., a metal) as the inductively heatable susceptor 80.

The aerosol generating device 30 further comprises an induction heating arrangement 52 for generating an alternating electromagnetic field that is capable of penetrating (i.e., coupling with) the inductively heatable susceptor 80 and the optional inductively heatable susceptor 82 to thereby inductively heat the inductively heatable susceptor(s) 80, 82. The induction heating arrangement 52 comprises a substantially helical induction coil 54. The induction coil 54 has a circular cross-section and extends around the substantially cylindrical heating chamber 42. The induction coil 54 can be energised by the power source 38 and controller 40. The controller 40 includes, amongst other electronic components, an inverter which is arranged to convert a direct current from the power source 38 into an alternating high-frequency current for the induction coil 54.

As will be understood by one of ordinary skill in the art, when the aerosol generating article 10 is positioned in the heating chamber 42 as shown in FIG. 5 and the induction coil 54 is energised during use of the aerosol generating system 200, an alternating and time-varying electromagnetic field is produced. This couples with and penetrates the inductively heatable susceptor 80 and the optional inductively heatable susceptor 82 and generates eddy currents and/or magnetic hysteresis losses in the susceptor(s) 80, 82 causing them to heat up. The heat is then transferred from the inductively heatable susceptors 80, 82 to the porous liquid storage material 12, primarily by conduction but possibly also by radiation and/or convection. The aerosol generating liquid stored in the porous liquid storage material 12 is thereby heated to a temperature at which one or more volatile components are released, causing the aerosol generating liquid to be vaporised and a vapour to be generated.

In order to ensure that the porous liquid storage material 12 is heated efficiently, it is important to ensure that the aerosol generating article 10 is positioned correctly in the heating chamber 42, in particular so that a longitudinal axis of the aerosol generating article 10 is aligned with a longitudinal axis of the heating chamber 42. The cooperation between the elongate inductively heatable susceptor 80 and the centrally positioned opening 14 in the porous liquid storage material 12 facilitates the correct positioning of the aerosol generating article 10 in the heating chamber 42. The correct positioning of the aerosol generating article 10 may also be facilitated by contact between the outer surface 18 of the porous liquid storage material 12 and the side wall 43 of the heating chamber 42 or the optional inductively heatable susceptor 82.

After positioning an aerosol generating article 10 in the heating chamber 42 of the aerosol generating device 30, a user can activate the aerosol generating device 30 (e.g., by a button press) to inductively heat the aerosol generating article 10, and more specifically the elongate inductively heatable susceptor 80 and the optional inductively heatable susceptor 82, in the manner described above to generate an inhalable aerosol. As discussed above, when the aerosol generating article 10 becomes depleted and no longer releases sufficient volatile components to generate an aerosol with acceptable qualities, the aerosol generating article 10 can be removed from the heating chamber 42 and a replacement aerosol generating article 10 can be inserted into the heating chamber 42 in its place.

Although exemplary embodiments have been described in the preceding paragraphs, it should be understood that various modifications may be made to those embodiments without departing from the scope of the appended claims. Thus, the breadth and scope of the claims should not be limited to the above-described exemplary embodiments.

Any combination of the above-described features in all possible variations thereof is encompassed by the present disclosure unless otherwise indicated herein or otherwise clearly contradicted by context.

Unless the context clearly requires otherwise, throughout the description and the claims, the words “comprise”, “comprising”, and the like, are to be construed in an inclusive as opposed to an exclusive or exhaustive sense: that is to say, in the sense of “including, but not limited to”.

1. An aerosol generating article for use with an aerosol generating device having a heating chamber, the aerosol generating article consisting of:
a porous liquid storage material for storing an aerosol generating liquid and configured for insertion into the heating chamber, the porous liquid storage material including an opening for receiving an elongate heating element of an aerosol generating device.

2. The aerosol generating article according to claim 1, wherein the porous liquid storage material comprises a self-supporting material.

3. The aerosol generating article according to claim 1, wherein the porous liquid storage material comprises a high retention material.

4. The aerosol generating article according to claim 1, wherein the opening is positioned substantially centrally within a cross-section of the porous liquid storage material.

5. An aerosol generating system comprising:
an aerosol generating device comprising a heating chamber and an elongate heating element which projects into the heating chamber; and
an aerosol generating article positioned in the heating chamber, the aerosol generating article consisting of:
a porous liquid storage material storing an aerosol generating liquid; and an opening in which the elongate heating element is positioned for heating and vaporising the stored aerosol generating liquid.

6. The aerosol generating system according to claim 5, wherein the elongate heating element is in thermal contact with an inner surface of the porous liquid storage material defined by the opening.

7. The aerosol generating system according to claim 5, wherein the elongate heating element comprises a pin heater or a blade heater.

8. The aerosol generating system according to claim 5, wherein the aerosol generating device comprises a further heating element which surrounds the porous liquid storage material.

9. The aerosol generating system according to claim 8, wherein the further heating element is mounted on a side wall of the heating chamber or defined by the side wall of the heating chamber.

10. The aerosol generating system according to claim 8, wherein the further heating element is in thermal contact with an outer surface of the porous liquid storage material.

11. The aerosol generating system according to claim 5, wherein the heating element comprises a resistance heating element.

12. The aerosol generating system according to claim 5, wherein the heating element comprises an inductively heatable susceptor and the aerosol generating device further comprises an induction heating arrangement for generating an alternating electromagnetic field for penetrating the inductively heatable susceptor to thereby inductively heat the inductively heatable susceptor.

13. The aerosol generating system according to claim 12, wherein the induction heating arrangement comprises an induction coil extending around the heating chamber.

14. The aerosol generating system according to claim 5, wherein the porous liquid storage material comprises a self-supporting material.

15. The aerosol generating system according to claim 5, wherein the porous liquid storage material comprises a high retention material.

16. The aerosol generating system according to claim 5, wherein the porous liquid storage material comprises a porous ceramic material.

17. The aerosol generating system according to claim 5, wherein the opening is positioned substantially centrally within a cross-section of the porous liquid storage material.

18. The aerosol generating article according to claim 1, wherein the porous liquid storage material comprises a porous ceramic material.
